(19) United States
(12) Patent Application Publication
(10) Pub. No.: US 2008/0230311 A1
(43) Pub. Date: Sep. 25, 2008

(54) Fall-arresting mechanism

(76) Inventors: Gabriele C. Fusco, Woodbridge (CA); Tajinderjit Bhela, Brampton (CA); Giuseppe Aprile, Markham (CA); Marco Maggiotto, Vaughan (CA)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/725,282

(22) Filed: Mar. 19, 2007

(51) Int. Cl. A62B 1/00

(52) U.S. Cl. 182/37

(57) ABSTRACT

For a generally vertical or curved structure, such as a ladder, tower, wall, or pole, which is equipped with a generally vertical or curved rail, a fall-arresting mechanism comprises an upper plate and a lower plate. Each plate has an aperture, through which the generally vertical rail extends. The mechanism further comprises an elongate, linking member, such as a strap, which is connected to one of the upper and lower plates. The upper and lower plates are linked, by a parallelogram linkage on each of two sides, so that the upper plate is pressed against the rail, in a given direction, while the lower plate is pressed against the rail, in an opposite direction, when the elongate, linking member is pulled downwardly or downwardly and away from the rail. The upper and lower plates are biased in the indicated directions. The mechanism further comprises a friction-enhancing wheel, which is biased against the rail.

### TECHNICAL FIELD OF THE INVENTION

This invention pertains to a fall-arresting mechanism of a type useful with a generally vertical and/or curved structure, such as a ladder, tower, wall, or pole, which is equipped with a generally vertical rail.

### BACKGROUND OF THE INVENTION

A fall-arresting mechanism of the type noted above, in widespread use, is available commercially from North Safety Products Canada Ltd. of Toronto, Ontario, Canada, and is similar to the fall-arresting mechanisms disclosed in U.S. Pat. No. 2,616,609 and U.S. Pat. No. 4,111,280. The disclosures of U.S. Pat. No. 2,616,609 and U.S. Pat. No. 4,111,280 are incorporated by reference herein.

The fall-arresting mechanism disclosed in U.S. Pat. No. 2,616,609 and U.S. Pat. No. 4,111,280 comprises a sleeve and a locking pawl, which may be also called a detent. The sleeve is movable along a generally vertical and/or curved rail, with which a ladder is equipped. One end of the locking pawl is connected to a belt, which is worn by a user, via a flexible chain. At spaced intervals along the rail, the rail is provided with similar notches. If the end that is connected to the belt and/or full body harness is pulled downwardly, as a consequence of the user falling, the locking pawl is pivoted so that another end of the locking pawl moves toward the rail, into one of the notches.

### SUMMARY OF THE INVENTION

This invention provides a fall-arresting mechanism for a generally vertical structure, such as a ladder, tower, wall, or pole, which is equipped with a generally vertical rail. The fall-arresting mechanism comprises an upper plate having an aperture, through which the generally vertical rail can extend, a lower plate having an aperture, through which the generally vertical rail can extend, and an elongate, linking member, which is connected to one of the upper and lower plates.

The upper and lower plates are linked so that the upper plate is pressed against the generally vertical rail, in a given direction, while the lower plate is pressed against the generally vertical rail, in an opposite direction, when the generally vertical rail extends through the apertures in the upper and lower plates and the elongate, linking member is pulled downwardly or downwardly and away from the carrier rail. The upper plate may be biased in the given direction and the lower plate may be biased in the opposite direction.

The upper and lower plates may be so linked via a linkage on each of two sides of the fall-arresting mechanism. The linkage on each of the sides may be a parallelogram linkage. The linkage may comprise means for biasing the upper plate in the given direction and the lower plate in the opposite direction.

The fall-arresting mechanism may comprise a friction-enhancing means, which is arranged to press against the generally vertical rail when the generally vertical rail extends through the apertures in the upper and lower plates. The friction-enhancing means may be biased against the generally vertical rail when the generally vertical rail extends through the apertures in the upper and lower plates. The friction-enhancing means may comprise a wheel, which is biased against the generally vertical rail and is rotatable around a generally horizontal axis when the generally horizontal rail extends through the apertures in the upper and lower plates. The wheel may be mounted operatively to the upper plate and/or the lower plate.

This invention also provides, for a ladder, tower, or pole, a combination comprising a rail, which is mountable to the ladder, tower, or pole so as to be generally vertical, and the fall-arresting mechanism described in the preceding four paragraphs.

### BRIEF DESCRIPTION OF THE DRAWINGS

FIG. 1 is a perspective view of a portion of a fall-arresting mechanism and rail attached to a ladder;

FIG. 2 is a side view of a fall-arresting mechanism as attached to secure a user via a harness;

FIG. 3 is a bottom perspective view of a lower plate of the fall-arresting mechanism;

FIG. 4 is a side perspective view of the fall-arresting mechanism taken along line 4-4 of FIG. 1;

FIG. 5 is a side perspective view of the fall-arresting mechanism of FIG. 4 as the linking member is pulled downwardly;

FIG. 6 is a top perspective view of the upper plate taken along line 6-6 of FIG. 4;

FIG. 7 is a top perspective view of the lower plate taken along line 7-7 of FIG. 4; and

FIG. 8 is a side view of a fall-arresting mechanism as attached to secure a user and harness.

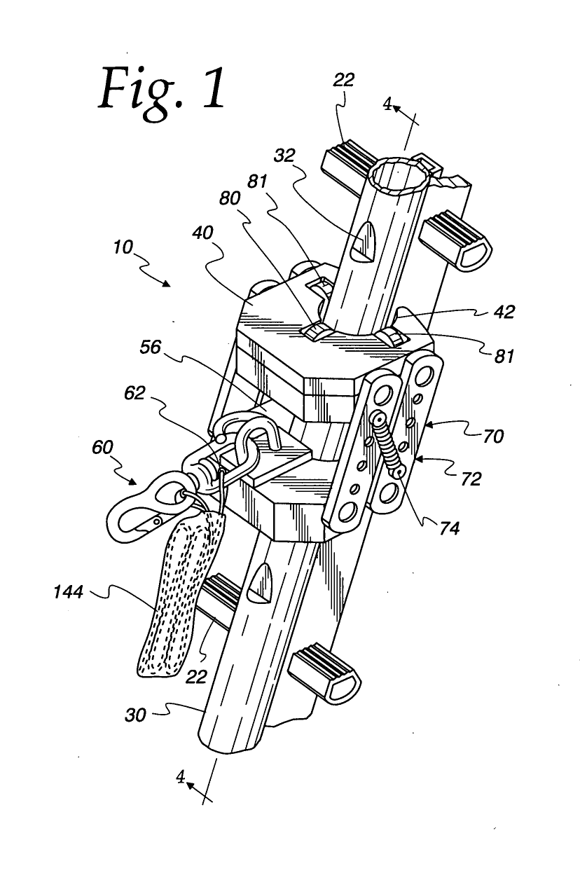

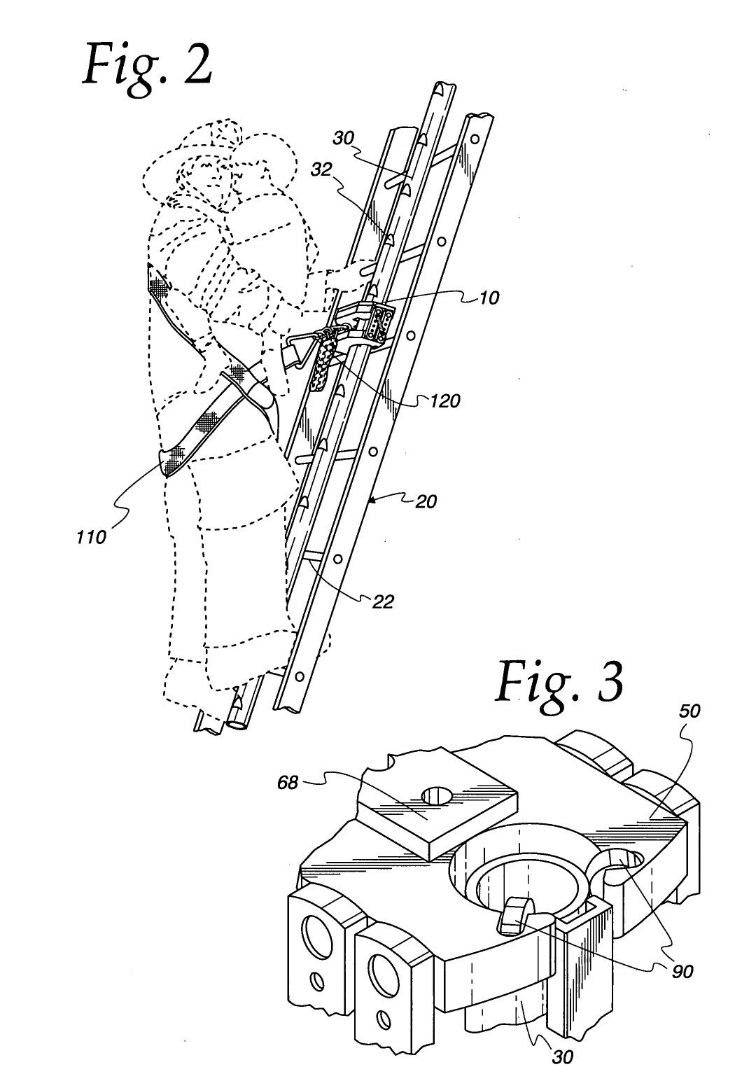

### DETAILED DESCRIPTION OF THE ILLUSTRATED EMBODIMENT

As illustrated, a fall-arresting mechanism 10 embodying this invention is used with a generally vertical or curved ladder 20, which is equipped with a generally vertical or curved rail 30. The rail 30 is clamped to rungs 22 of the ladder 20, in a manner disclosed in U.S. Pat. No. 2,616,609 and U.S. Pat. No. 4,111,280. The rail 30 includes a series of spaced notches 32. These notches 32 can be used to interact with the fall-arresting mechanism 10 as discussed below. Alternatively, the rail 30 is useful with another generally vertical, similarly equipped structure, such as a tower, wall, pole, water tank and other similar structures.

Broadly, the fall-arresting mechanism 10 comprises an upper plate 40 having an aperture 42, which has an open mouth 44 and through which the rail 30 extends, a lower plate 50 having an aperture 52, which has an open mouth 54 and through which the rail extends, and an elongate, linking member 60, one end 62 of which is connected to the lower plate 50, at an upper surface 56 of the lower plate 50.The mouths 44, 54, of the apertures 42, 52, of the upper and lower plates 40, 50, enable the fall-arresting mechanism 10 to be removed from the rail 30, at dismount locations, which are not illustrated, in a manner disclosed in U.S. Pat. No. 4,111,280. The fall-arresting mechanism is also generally removable at the top and bottom of the rail.

The upper and lower plates 40, 50, are linked by two parallelogram linkages 70, each of which comprises two parallel links 72 on one of two sides of the fall-arresting mechanism 10, so that the upper plate 40 is pressed against the rail 30, in a given direction, i.e., away from the ladder 10, and the lower plate 50 is pressed against the rail 30, in an opposite direction, i.e., toward the ladder 10, when the rail extends generally vertically, through the apertures in the upper and lower plates 40, 50, and the elongate, linking member 60 is pulled downwardly or downwardly and away. The fall-arresting mechanism 10 may also include linkages 70 on two sides of the fall-arresting mechanism 10.

The upper plate 40 has two similarly curved surfaces 48, one at each side of the mouth 44 of the aperture 42, which are shaped so as to be pressed snugly against the rail 30 when the upper plate 40 is pressed against the rail 30, in the given direction, i.e., away from the ladder 10. The lower plate 50 has a curved surface 58, which is opposite the mouth 54 of the aperture 52 and which is shaped so as to be pressed snugly against the rail 30 when the lower plate 50 is pressed against the rail 30, in the opposite direction, i.e., away from the ladder 10. One of the parallelogram linkages 70 is provided with a coiled spring 74, which is tensioned so as to bias the upper plate 40 against the rail 30, in the given direction, i.e., away from the ladder 10, and the lower plate 50 against the rail 30, in the opposite direction, i.e., toward the ladder 10. It should be understood that two of the parallelogram linkages 70 may be provided with a coiled spring 74. Furthermore, it should be understood that there may be two or more coiled springs 74.

Additionally, one of the upper and lower plates 40,50 has a locking tooth 68 which is arranged to interlock with one of the series of spaced notches 32 of the carrier rail 30. As seen in FIG. 5, the locking tooth 68 is arranged on the lower plate 50 and has interlocked with one of the notches 32 of the rail 30.

When the upper plate 40 thus is pressed against the rail 30, in the given direction, i.e., away from the ladder 10, and the lower plate 50 thus is pressed against the rail 30, in the opposite direction, i.e., toward the ladder 20, as a consequence of the user falling so as to pull the elongate, linking member 60 downwardly, or downwardly and toward or away from the ladder 20, frictional engagement of the curved surfaces 48 of the upper plate 40 with the rail 30 and frictional engagement of the curved surface 58 of the lower plate 50 with the rail 30 arrest the generally downward movement of the fall-arresting mechanism 10 along the rail 30 and, consequently, arrest the user's fall. Furthermore, the locking tooth 68 interlocks with one of the notches 32 of the rail 30 as the fall-arresting mechanism is pulled downwardly or downwardly and away from the rail 30. It should be understood by those skilled in the art that the linking member 60 may be flexible so as to absorb some of the force of the user falling.

The fall-arresting mechanism 10 further comprises a friction-enhancing wheel 80, which is mounted operatively to the upper plate 40 and may be biased against the rail 30, via coiled springs (not shown), and is rotatable around a generally horizontal axis when the rail extends through the apertures 42, 52, in the upper and lower plates 40, 50. The fall-arresting mechanism 10 further comprises two guiding wheels 90, which are mounted operatively to the lower plate 50. The friction-enhancing wheel 80 and the guiding wheels 90 are positioned so that the fall-arresting mechanism 10 is pulled upwardly along the rail 30, as the user climbs the ladder 20, while the friction-enhancing wheel 80 keeps the fall-arresting mechanism 10 from sliding downwardly along the rail 30. Furthermore, it should be understood that the fall-arresting mechanism 10 may include additional wheels 81.

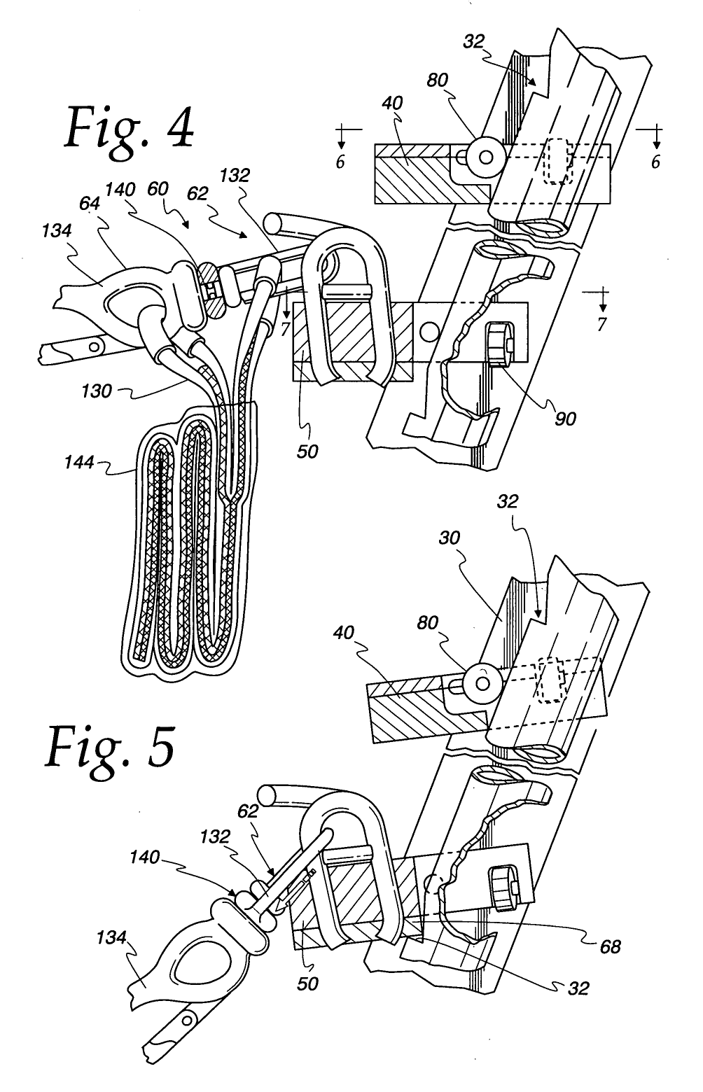

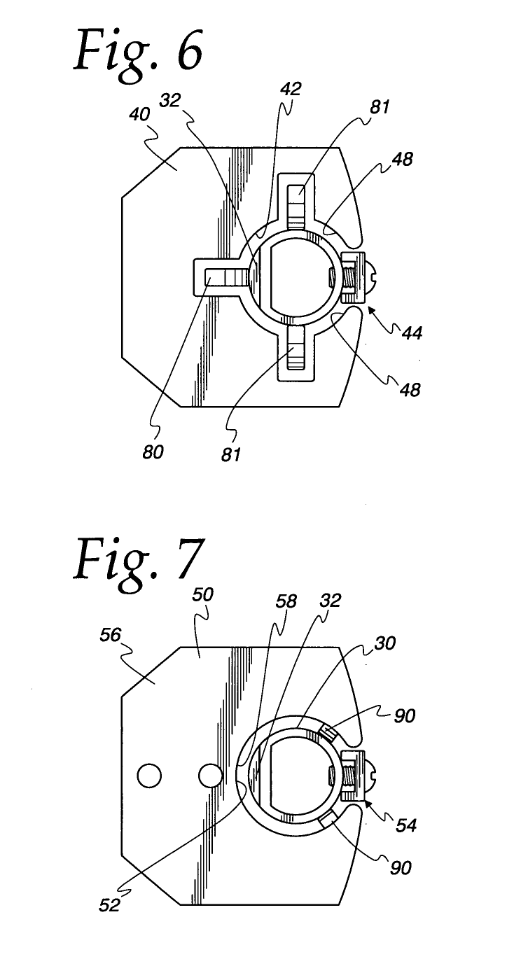

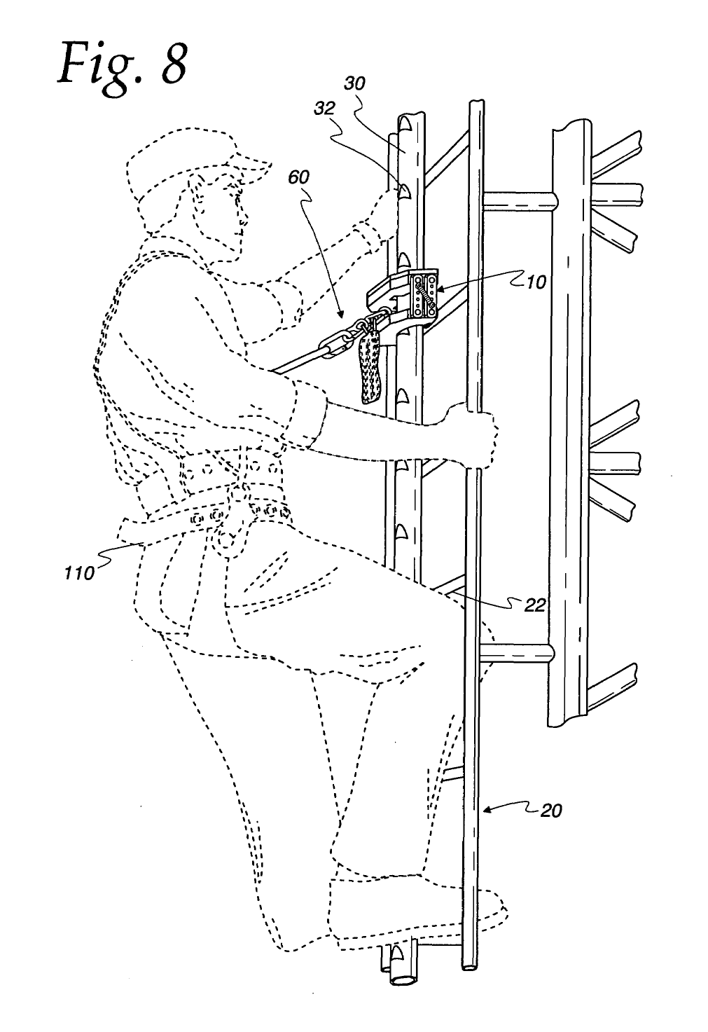

As illustrated, the elongate, linking member 60 comprises a fabric strap 130, such as a nylon or polyester strap, which is connected at the end 62, to the lower plate 50. Alternatively, the elongate, linking member 60 comprises a cable or a chain. As best illustrated in FIG. 4, in addition to the strap 130, the linking member 60 may also include connecting members 132 and 134. The connecting member 132 connects the strap 130 to the lower plate 50. The strap 130 is also connected to the connecting member 134 at the opposite edge 64. Furthermore, at its opposite end 64, the elongate, linking member 60 is connected to a harness 110, which is worn by a user, via a carabiner 120 or other connecting means at a position above the user's center of gravity. It should be understood that a wide variety of harnesses, such as full body harnesses may be used with the fall-arresting mechanism 10.

The linking member 60 may also include a severable member, such as a shear pin 140. The shear pin 140 can be used to provide a severable connection between the connecting members 132, 134. In this form, the connecting member 132, 134 and shear pin 140 receive most of the forces from ascending and descending by the user. However, in an instance where the user falls, the shear pin 140 will sever, thereby separating the connection members 132, 134 and permitting the strap 130 to slow and absorb the force of the fall. Therefore, wear on the strap 130 is minimized as it does not absorb any force unless the user is falling. Additionally, the linking member 60 may also include a sheath 142 which can be used to house the strap 130. The sheath 142 can be used to prevent the strap from being abraded and/or caught on various protrusions, thereby further maintaining the integrity of the strap 130.

As illustrated, the rail 30 is tubular with an outer wall that is generally circular in cross-section, as disclosed in U.S. Pat. No. 2,616,609 and U.S. Pat. No. 4,111,280. Alternatively, the rail 30 may have a different cross-sectional shape, such as the cross-sectional shape of a box beam or of an I-beam, whereupon the apertures 42, 52, of the upper and lower plates 40, 50, must be shaped conformably.

1. For a ladder-equipped or climbable structure, which is equipped with a carrier rail having a series of spaced notches, a fall-arresting mechanism comprising an upper plate having an aperture, through which the carrier rail can extend, a lower plate having an aperture, through which the carrier rail can extend, and a linking member, which is connected to one of the upper and lower plates, the upper and lower plates being linked so that the upper plate is pressed against the carrier rail, in a given direction, and the lower plate is pressed against the carrier rail, in an opposite direction, when the carrier rail extends through the apertures in the upper and lower plates and the linking member is pulled downwardly or downwardly and away from the carrier rail, wherein one of the upper and lower plates has a locking tooth, which is arranged to interlock with one of the series of spaced notches of the carrier rail when the carrier rail extends through the apertures in the upper and lower plates and the linking member is pulled downwardly or downwardly and away from the carrier rail.

2. The fall-arresting mechanism of claim 1, wherein the linking member is connected to the lower plate.

3. The fall-arresting mechanism of claim 2, wherein the linking member is connected to the lower plate, at an upper surface of the lower plate.

4. The fall-arresting mechanism of claim 1, wherein the upper and lower plates are linked via a linkage on each of two sides of the fall-arresting mechanism.

5. The fall-arresting mechanism of claim 4, wherein the linkage on each of the sides comprises a parallelogram linkage.

6. The fall-arresting mechanism of claim 1, wherein the upper plate is biased in the given direction and the lower plate is biased in the opposite direction.

7. The fall-arresting mechanism of claim 6, wherein the linkage comprises means for biasing the upper plate in the given direction and the lower plate in the opposite direction.

8. The fall-arresting mechanism of claim 1 wherein the linking member includes a fabric strap and a sheath covering substantially all of the fabric strap.

9. The fall-arresting mechanism of claim 1 wherein the linking member includes a first connecting member located at a first end of the linking member, a second connecting member located at a second end of the linking member and a severable member directly connecting the first and second connecting members.

10. For a ladder-equipped or climbable structure, which is equipped with a carrier rail having a series of spaced notches, a fall-arresting mechanism comprising an upper plate having an aperture, through which the carrier rail can extend, a lower plate having an aperture, through which the carrier rail can extend, and a linking member, which is connected to one of the upper and lower plates, the upper and lower plates being linked so that the upper plate is pressed against the carrier rail, in a given direction, and the lower plate is pressed against the carrier rail, in an opposite direction, when the carrier rail extends through the apertures in the upper and lower plates and the linking member is pulled downwardly or downwardly and away from the carrier rail, wherein the fall-arresting mechanism further comprises friction-enhancing means arranged to press against the generally vertical rail when the generally vertical rail extends through the apertures in the upper and lower plates, so as to retard downward movement of the fall-arresting mechanism along the carrier rail not only when the linking member is not being pulled but also when the linking member is being pulled downwardly, away from the rail, or downwardly and away from the rail.

11. The fall-arresting mechanism of claim 10, wherein the friction-enhancing means comprises a wheel, which is biased against the generally vertical rail and is rotatable around a generally horizontal axis when the generally vertical rail extends through the apertures in the upper and lower plates.

12. The fall-arresting mechanism of claim 11, wherein the wheel is mounted operatively to the upper plate.

13. The fall-arresting mechanism of claim 10 wherein the linking member includes a fabric strap and a sheath covering substantially all of the fabric strap.

14. The fall-arresting mechanism of claim 10 wherein the linking member includes a first connecting member located at a first end of the linking member, a second connecting member located at a second end of the linking member and a severable member directly connecting the first and second connecting members.

15. The fall-arresting mechanism as in any one of claims 10-14, wherein one of the upper and lower plates has a locking tooth, which is arranged to interlock with one of the series of spaced notches of the carrier rail when the carrier rail extends through the apertures in the upper and lower plates and the linking member is pulled downwardly or downwardly and away from the carrier rail.

16. The fall-arresting mechanism of claim 15, wherein the linking member is connected to the lower plate.

17. The fall-arresting mechanism of claim 16, wherein the linking member is connected to the lower plate, at an upper surface of the lower plate.

18. The fall-arresting mechanism of claim 15, wherein the upper and lower plates are linked via a linkage on each of two sides of the fall-arresting mechanism.

19. The fall-arresting mechanism of claim 18, wherein the linkage on each of the sides comprises a parallelogram linkage.

20. The fall-arresting mechanism of claim 15, wherein the upper plate is biased in the given direction and the lower plate is biased in the opposite direction.

21. The fall-arresting mechanism of claim 20, wherein the linkage comprises means for biasing the upper plate in the given direction and the lower plate in the opposite direction.
